(19) United States
(12) Patent Application Publication
(10) Pub. No.: US 2007/0275805 A1
(43) Pub. Date: Nov. 29, 2007

(54) Plate-link chain and method for producing it

(75) Inventor: Johannes Huttinger, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/800,444

(22) Filed: May 4, 2007

Related U.S. Application Data
(60) Provisional application No. 60/800,991, filed on May 17, 2006.

(30) Foreign Application Priority Data
May 6, 2006 (DE) 10 2006 021 221.5

(51) Int. Cl. F16G 13/04; F16G 5/16

(52) U.S. Cl. 474/215; 474/245

(57) ABSTRACT

A plate-link chain including plates having at least one ear, and rocker pressure members interconnecting the plates. The wear of chain guide tracks or guide rails during movement of the plate-link chain relative to the guide tracks or guide rails is reduced by removing the ears from the plates after the plate-link chain is assembled. The ear removal is effected by machining or grinding off the ears.

### BACKGROUND OF THE INVENTION

1. Field of the Invention

The present invention relates to a plate-link chain that includes plates having at least one ear on an outer edge and rocker pressure members connecting the plates, as well as to a method for producing such a chain.

2. Description of the Related Art

Plate-link chains, as well as toothed plate-link chains, have ears as assembly aids, which are located on the outwardly-facing side of the chain when it is in the installation position. Plate-link chains, or toothed plate-link chains, are employed in continuously variable transmissions, known as CVT's, for example. Because of the ears, after rather long use there is increased guide track or guide rail wear on guide tracks or guide rails provided for guiding the chain or for limiting transverse oscillations of the chain.

An object of the present invention is therefore to provide a plate-link chain, which can be a toothed plate-link chain, and a method for producing it, which reduces the wear of the guide tracks or guide rails.

### SUMMARY OF THE INVENTION

The object is achieved by a plate-link chain that includes plates having at least one outer ear, and rocker pressure members that connect the plates, wherein the ear is removed after the plate-link chain is assembled. The object is also achieved by a method for producing a plate-link chain that includes plates having at least one outer ear, and rocker pressure members interconnecting the plates, including the procedural steps of assembly of the plates and rocker pressure members and the removal of the ear. In that regard, the term plate-link chain also includes a toothed plate-link chain. As a rule, there are one or two ears arranged on each plate. But there can also be one or more ears arranged on only some of the plates. Thus, in accordance with the present invention the ears are removed only after the chain has been completely assembled.

Preferably, it is provided that the ear be removed by machining. The machining preferably includes grinding, with special preference for wet and/or dry grinding. Metallic particles are preferably removed from the processing site during the processing, which is preferably accomplished magnetically and/or by means of a flowing medium, in particular a liquid or pressurized air.

The machining depth is preferably determined so that that no heat treatment of the rocker members occurs, in particular no tempering, and the prior heat treatment of plates and rocker pressure members is not changed. Preferably there is provision for the plate-link chain to be stretched in a further processing step. The removal of the ear is preferably followed by a cleaning step, which is preferably performed by means of pressurized air and/or a cleaning fluid.

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a section of a known plate-link chain; FIG. 2 is a top view of the plate-link chain shown in FIG. 1;

FIG. 3 is a side view similar to FIG. 1 of another plate-link chain with plate links having ears and after assembly;

FIG. 4 is a side view of the plate-link chain of FIG. 3 after removal of the ears; and

FIG. 5 is a flow chart showing the several steps of the method in accordance with the invention.

### DESCRIPTION OF THE PREFERRED EMBODIMENTS

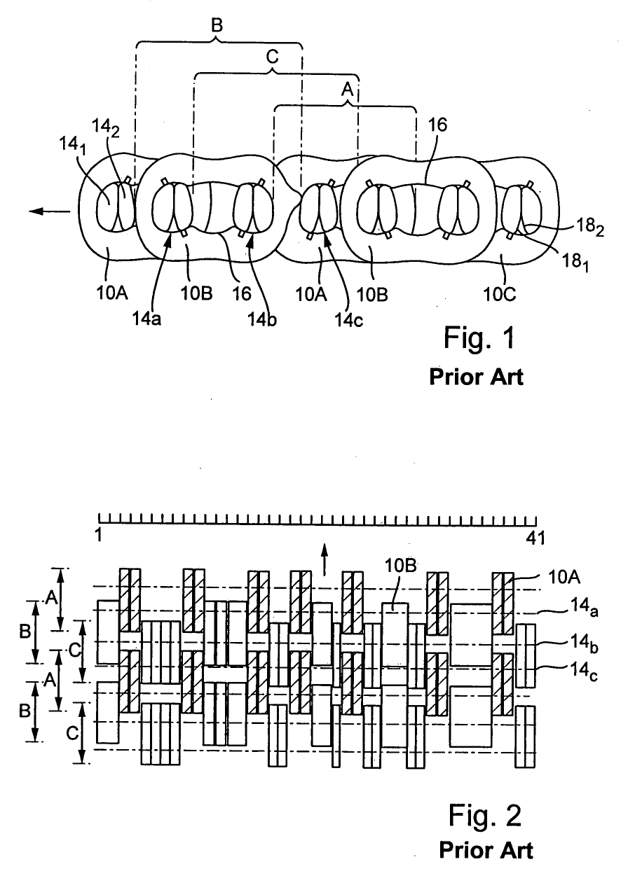

FIG. 1 is a side view of a section of a known plate-link chain, and

FIG. 2 shows a schematic top view of the plate-link chain shown in FIG. 1. Such a plate-link chain is assembled from plates 10, which are arranged one after another in a predetermined pattern in a plurality of side-by-side rows relative to the longitudinal direction of the plate-link chain. In the illustrated example 41 rows are shown. The plates of at least some adjacent rows are offset from each other in the longitudinal direction of the plate-link chain, so that a group of pins or pairs of rocker pressure members 14 that extend through and interconnect the plates and that extend transversely of the plate-link chain, in each case extend through at least two plates that are arranged offset from each other in the longitudinal direction. More precisely, a pair of rocker pressure members 14a extends through plates 10A and plates 10B; a pair of rocker pressure members 14b extends through plates 10B and plates 10C; a pair of rocker pressure members 14c extends through plates 10C and again plates 10A, whereupon the arrangement repeats.

The pair of rocker pressure members 14a extends through the plates 10B in such a way that it is positioned at the front end of an opening 16 in the plates, which opening extends in the running direction of the plate-link chain (the direction shown by the arrow), whereas it is at the rear end of the openings of plates 10A in the running direction of the plate-link chain. The arrangement is analogous for the other pairs of rocker pressure members. In that way the outer surface of the front rocker pressure member 14₁ of rocker pressure member pair 14a which lies forwardmost in the running direction is supported at the front end of opening 16 of plates 10B, whereas the rear end of opening 16 of plates 10A is supported on the outer surface of the rear rocker pressure member 142 of rocker pressure member pair 14a. The openings and the rocker pressure members that contact the ends of the openings are so shaped that the rocker pressure members are nonrotatably held at the respective associated end faces of the openings. When the chain bends, the mutually facing surfaces 18₁ and 18₂ of the rocker pressure members of a rocker pressure member pair roll against each other, so that there is largely friction-free bending of the plate-link chain.

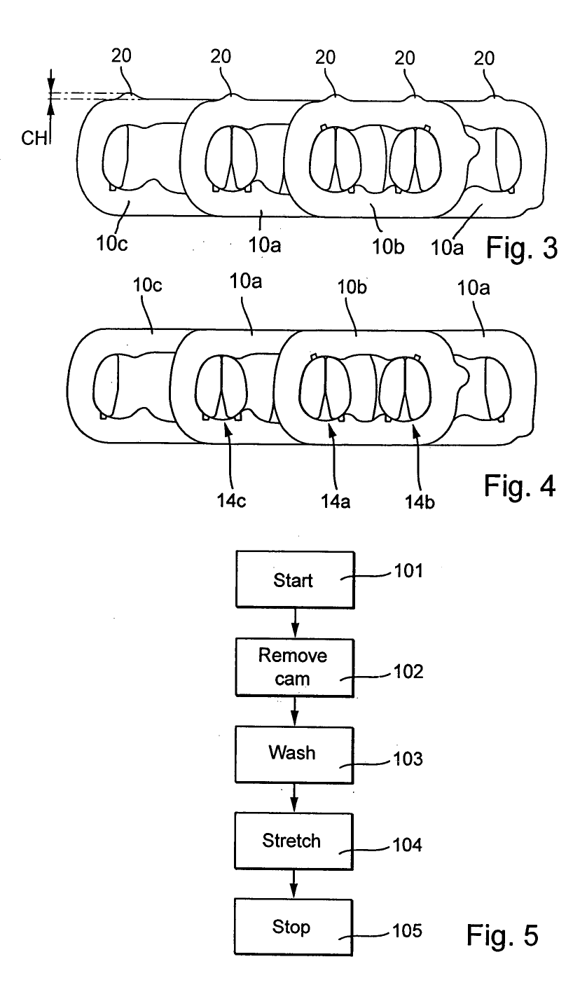

FIG. 3 shows a side view similar to FIG. 1 of a plate-link chain immediately after assembly. The plate-link chain shown in FIG. 3 includes plates 10, which have substantially flat upper surfaces, with only small concave or convex regions between the rocker members of a rocker member pair. The result is that in contrast to the chain illustrated in FIG. 1, when the assembled chain of FIG. 3 is stretched it has an essentially straight and flat upper surface, as shown in FIG. 4. As an aid to chain assembly, during production plates 10a, 10b, 10c are each provided with two ears 20 having an ear height CH. Among other things, the ears 20 can serve to position the plates 10 relative to each other in the running direction of the chain during assembly of the chain, and also to enable introduction of the rocker pressure members 14 into the openings in plates 10, for example. The ears 20 are produced, for example, when stamping the plates 10. In accordance with the present invention, the ears are removed only after the chain is assembled, so that in side view the chain has the form shown in FIG. 4, i.e., without the ears 20. The method for assembling the chain and removing the ears will be described below.

The manufacturing process will be described on the basis of the flow chart shown in FIG. 5. The process begins at Step 101, after the chain has been assembled. In Step 102 assembly ears 20 are ground off or cut off on a linear grinding machine. The chain is then in a stretched, pre-tensioned condition, in order to ensure alignment of the plates relative to each other. The grinding or cutting off operation on the linear grinding machine is done with as little residual dust as possible, i.e., with the chain cleaned, and with as little burr formation as possible in or on the chain. The low burr formation is achieved by strong suctioning of the dust particles, slow feeding while grinding (which results in a shallow cutting depth) and a powerful magnet by the grinding wheel to transport machined material away. When machining with coolant, provision is made for a high flow rate of rinsing or cooling agent, in order to reduce the heat treatment of the plate by the machining. A process of washing the chain follows in Step 103, in particular if the grinding or cutting in Step 102 is done without the addition of cooling agents or lubricants. Otherwise Step 103 can be dispensed with. That is followed by stretching the chain in Step 104, which is intended to press out the burr that has developed in the loop, and with the plates side-by-side. In addition, the stretching checks whether any prior damage to the plate contour could result in rejects. The process ends at Step 105.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate-link chain comprising: a plurality of link plates including an opening positioned interiorly of an outer periphery, wherein the outer periphery includes at least one outwardly-extending ear; a plurality of rocker pressure members extending through respective plate openings for interconnecting the plates in side-by-side relationship in a predetermined plate pattern, wherein the at least one outwardly-extending ear is removed after assembly of the plate-link chain by the interconnection of the link plates and the rocker pressure members.

2. A method for producing a plate-link chain that includes a plurality of link plates having at least one outwardly-extending ear extending from an outer periphery of the link plates, and a plurality of rocker pressure members interconnecting the link plates, said method comprising the steps of:
assembling the link plates and the rocker pressure members by interconnecting the link plates and rocker members to form a plate-link chain in which the link plates are positioned in side-by-side relationship in a predetermined link plate pattern; and
removing the outwardly-extending ears after assembly of the plate-link chain but before placing the chain into service.

3. A method in accordance with claim 2, wherein removal of the ears is effected by machining the ears to provide substantially flat and parallel edges of correspondingly-positioned outer surfaces of the link plates.

4. A method in accordance with claim 3, wherein the machining is effected by grinding the ears.

5. A method in accordance with claim 4, wherein the grinding of the ears includes at least one of wet and dry grinding of the ears.

6. A method in accordance with claim 5, wherein metallic particles are removed from ear regions during an ear machining operation.

7. A method in accordance with claim 6, including the step of subjecting a region adjacent to the ears to a magnetic field to remove metallic particles generated during ear grinding.

8. A method in accordance with claim 6, including the step of flowing a fluid medium in a region adjacent to the ears to remove metallic particles generated during ear grinding.

9. A method in accordance with claim 3, wherein the machining depth is performed to avoid property-altering heat treating of the link plates and the rocker members during machining of the ears.

10. A method in accordance with claim 2, including the step of applying in a longitudinal direction of the plate-link chain a tensile stretching force after removal of the ears.

11. A method in accordance with claim 3, including the step of removing machining debris from adjacent the ears before placing the chain in service.

12. A method in accordance with claim 11, wherein the machining debris removal step is performed by subjecting the ears to the flow of a flowing cleaning fluid.

13. A method in accordance with claim 8, wherein the fluid medium is a liquid.

14. A method in accordance with claim 8, wherein the fluid medium is pressurized air
